(19) United States
(12) Patent Application Publication
(10) Pub. No.: US 2022/0316236 A1
(43) Pub. Date: Oct. 6, 2022

(54) HARDWARE-LESS DOOR HANDLE

(71) Applicant: Steven Donald Watford, Sachse, TX (US)

(72) Inventor: Steven Donald Watford, Sachse, TX (US)

(21) Appl. No.: 17/702,094

(22) Filed: Mar. 23, 2022

Related U.S. Application Data
(60) Provisional application No. 63/168,508, filed on Mar. 31, 2021.

(51) Int. Cl. E05B 1/00

(52) U.S. Cl. CPC E05B 1/0069; E05Y 2900/132

(57) ABSTRACT

A handle for a hinged door comprises a first portion having a flat affixing surface. A second portion is spaced apart from and parallel to the first portion. A third portion connected to lateral edges of the first and second portion form a U shape having an opening away from the third portion.

### CROSS-REFERENCE TO RELATED APPLICATIONS

This application claims the benefit of U.S. Provisional Patent Application No. 63/168,508, filed on Mar. 31, 2021, entitled “HARDWARE-LESS DOOR HANDLE”, which is hereby incorporated by reference in its entirety for all that is taught and disclosed therein.

### FIELD OF THE INVENTION

The present invention relates to door handles.

### BACKGROUND AND SUMMARY

The Covid-19 Pandemic and the future of a post-Covid world have radically shifted society's attitude toward shared surfaces, most notably: door handles. Many products have come to market over the last year but have failed to address the numerous obstacles associated with “re-inventing” the way we open doors.

The most jarring problem of these current products is the misunderstanding and/or negligence of basic ergonomics. Upward facing handles look great on advertisement photos because they depict the user reaching forward and down with the wrist or forearm, however, they don't show the unnatural motions required to actually open the door; the basic problem is that the user is pulling the door into themself while the elbow is forced forward into an uncomfortable and dangerous position as the door continues to open. IF the user manages to not hit themself with the door, they must quickly and awkwardly remove their arm from behind a now open door and then enter the room before the door begins to close. It's an impractical series of movements and a pivotal reason these designs haven't caught on.

Another major unresolved hurdle is the installation process. Current products available require extensive hardware and considerable maintenance skill which is expensive, time consuming, aesthetically unappealing, and does permanent damage to the door. These are problems no property owner wants to deal with.

The above disadvantages are addressed by a handle for a hinged door that comprises a first portion having a flat affixing surface. A second portion is spaced apart from and parallel to the first portion. A third portion connected to lateral edges of the first and second portion form a U shape having an opening away from the third portion.

### BRIEF DESCRIPTION OF THE DRAWINGS

FIG. 1 shows an overview of the handle in a CAD drawing. The handle is essentially a modified U-Bracket with a flat back side for level installation and “exit” lips protruding outward and upward on the front side for an easy and comfortable removal of the wrist/forearm. The thickness of the injection molded handle is currently set at 0.22 inches but is subject to change upon field testing.

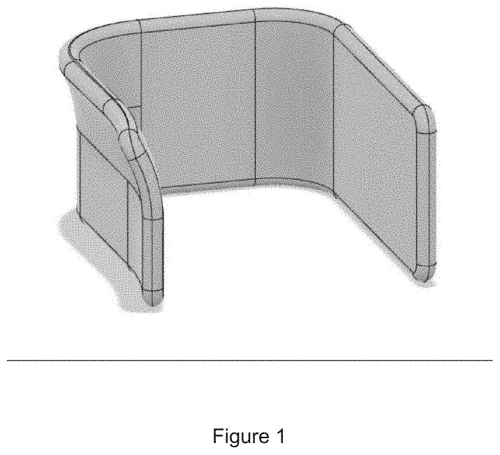

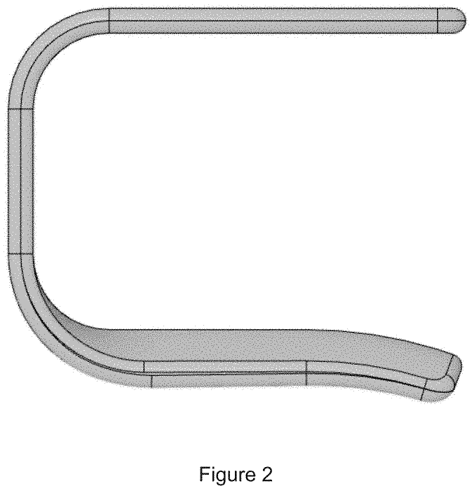

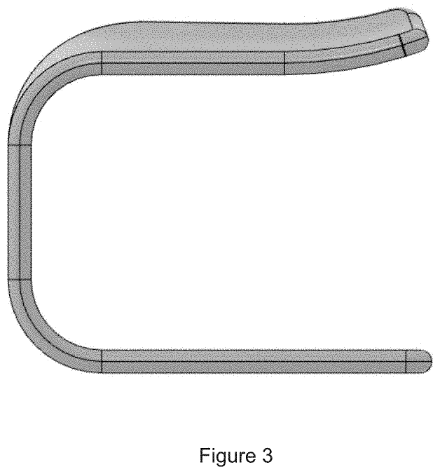

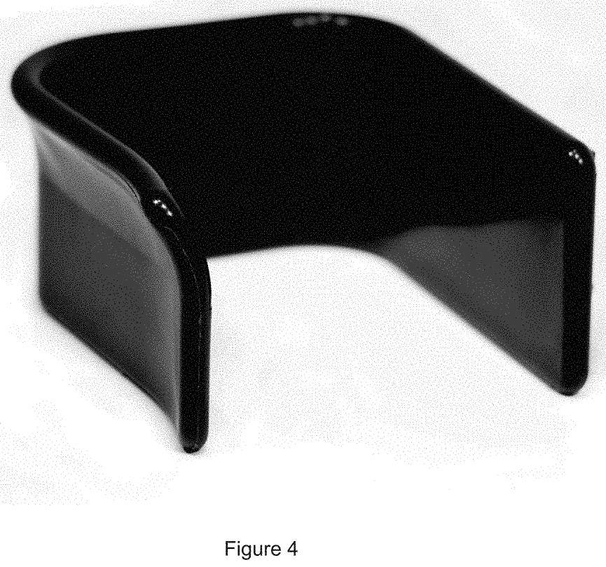

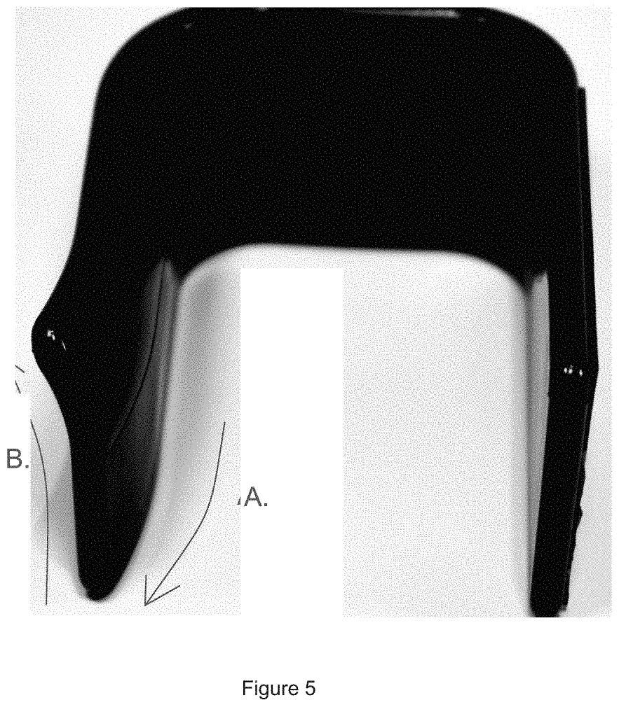

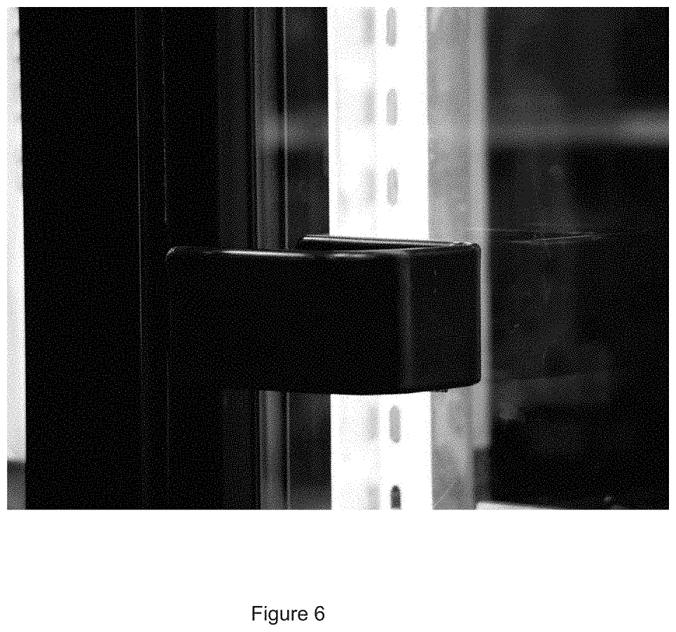

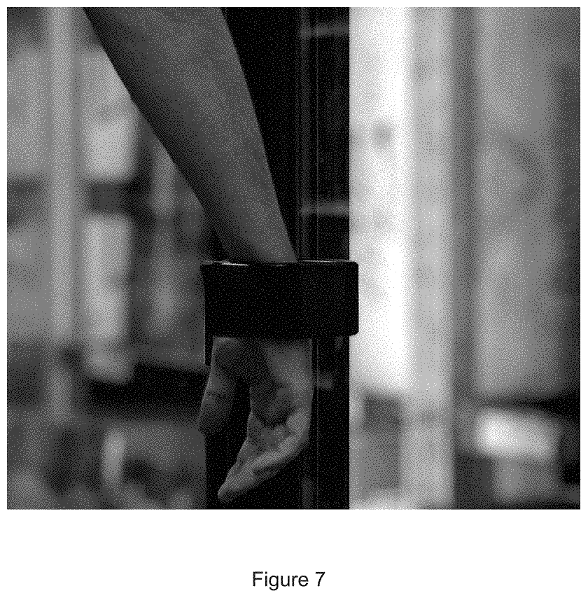

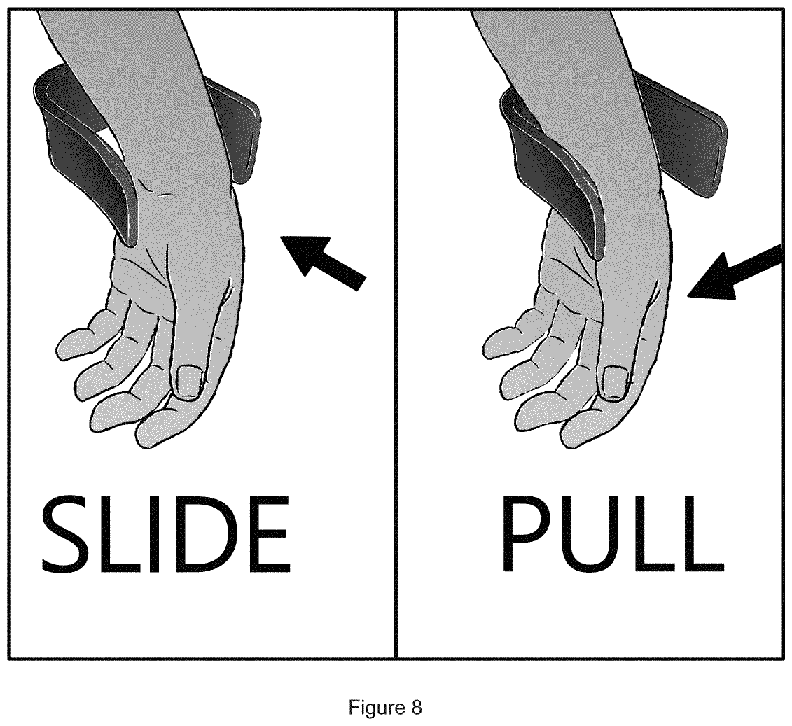

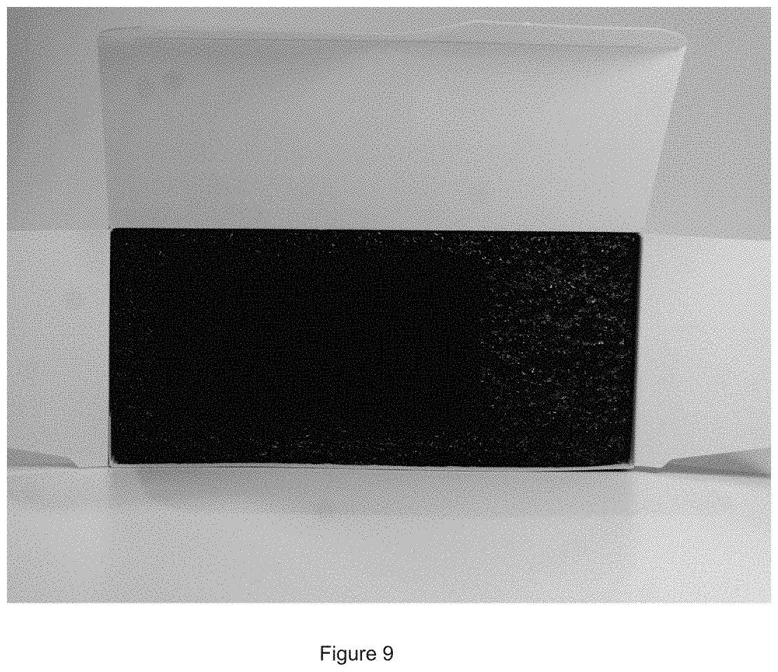

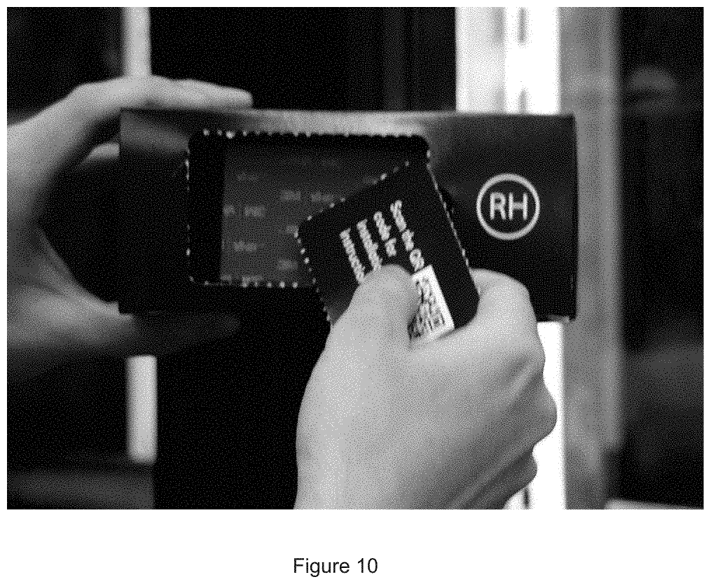

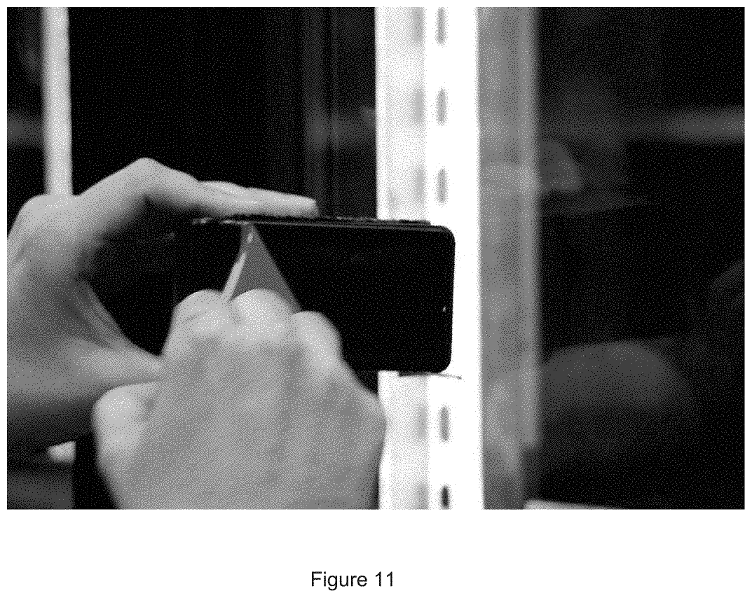

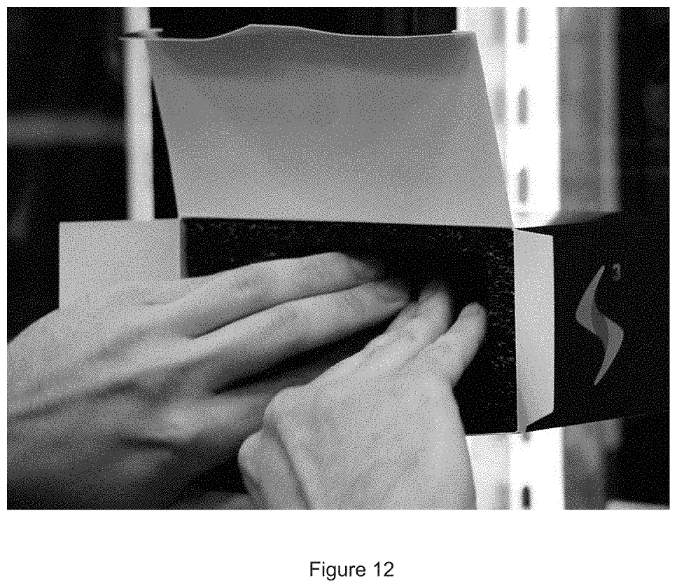

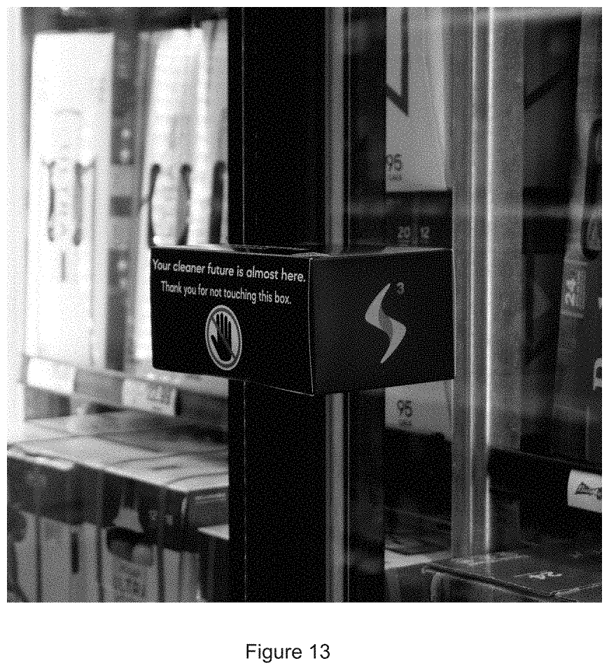

*Not shown in this drawing are the draft angles necessary for injection molding. Depending on what the manufacturer recommends, there will be draft angle of 0.5 or 1 degree on the faces in order to protect the mold and product during the injection molding process.

The material used during this process is a polymer known as Nymax GF 600 A 33, a Polyamide engineered specifically for applications requiring high stiffness, tensile strength, and toughness. I'm opting for a 600-grit paper finish for comfort and aesthetic purposes. An anti-microbial additive developed by Microban is mixed in during the manufacturing process to reduce the growth of bacteria and dangerous microbes.

This handle has been designed for all doors that don't require a knob or handle to disengage a locking mechanism. Examples include commercial doors at fast food restaurants, banks, and refrigerator doors at supermarkets. With the 3M VHB 5952, the handle can adhere to glass, steel, metal, and plastic.

Note 1: I also have the ability to manufacture this handle out of 3/16″ mild steel with a custom press brake and edge rounding finishing machine. The only difference in products is that the steel version doesn't have draft angles since they aren't necessary.

FIG. 2 shows the top of the handle in a CAD drawing. The back of the handle (top of picture) is straight while the front of the handle (bottom of picture) curves forward approximately ¼″ inch. The edges have been designed with a fillet to eliminate any right angles as they are uncomfortable and potentially unsafe, especially when manufacturing with steel or other metals.

*The mold for the injection molding process accounts for this rounded edge while the steel handles will go through an edge rounding machine to achieve the same result.

FIG. 3 shows the bottom of the handle in a CAD drawing. The width is slightly thinner than the top of the handle because of the draft angles necessary for the manufacturing process.

FIG. 4 is a photographed Wrist Grip on a white background. This image captures an open view of the “exit” curves, rounded edges, and rounded face. This design choice was made to promote quick and easy cleaning with a simple wipe down using a sanitary product such as a Lysol Wipe; there are no corners for germs and grime to build up. Additionally, the lack of edges boasts a safer product because users are less likely to injure themselves without a “sharp” edge.

FIG. 5 illustrates the “exit” curves that make the Wrist Grip unique. A) is the curve that allows a comfortable removal of the user's wrist or forearm, while B) depicts the curve that allows a comfortable user experience as a result of removing the 90-degree angle of an ADA compliant handle.

FIG. 6 shows the Wrist Grip on a glass door without hardware at an ADA compliant height approximately 1.875″ from the door frame.

FIG. 7 depicts the wrist/forearm comfortably resting in the Wrist Grip. The curve at the top of the Wrist Grip provides a comfortable user experience when the wrist/foreman is inserted from any angle.

FIG. 8 is an artist's rendering showing how the Wrist Grip is used. At an ADA installed height, the Wrist Grip is accessible by anyone. Simply slide the wrist/forearm into the Wrist Grip and pull. The ergonomics of the human body and functionality of a hinged door provide a safe and comfortable user experience.

FIG. 9 shows an inside view of the installation template. A foam insert included inside of the packaging ensures a level installation as well as a standard 1.875″ separation from the door frame to promote a comfortable user experience.

FIG. 10 shows the removal of the perforated tab being removed from the packaging exposing the Wrist Grip and adhered 3M 5952 tape.

FIG. 11 shows the 3M 5952 tape being removed prior to the Wrist Grip's installation.

FIG. 12 shows the Wrist Grip being installed to the door by pushing the handle firmly through the installation template built into the packaging.

FIG. 13 shows the Wrist Grip packaging attached to the door during the tape curing process. After 72 hours, the packaging is disposed of and the Wrist Grip is secured to the door.

### DETAILED DESCRIPTION OF A PREFERRED EMBODIMENT

The Wrist Grip (Hardware-less Door Handle) is the first “hands-free” door handle designed with the user and property owner in mind. This ergonomically designed handle accommodates the natural motions of the human body allowing the user to open a door safely and comfortably without unnecessary movements. The handle opening faces the door frame rather than the ceiling so the user simply reaches from the side, pulls the handle away from their body as the door opens, and then enters the room as they comfortably slide their wrist/forearm out of the handle with help from the “exit” curves.

Equally important to the handle's functionality is how the Wrist Grip is installed. Rather than using traditional fasteners that require holes (irreversible damage), the Peel 'n Press utilizes 3M's VHB 5952 double sided tape which adheres the handle to the door with a bond that is nearly impossible to break. What this means is that the installation process consists of removing the protective coating from the tape and then firmly pressing the handle to the door. That's it. After a brief curing time (4 hours), the bond is secured and the handle is ready for use. No damage to the door, no special skills, and no expensive hardware. But the handle can be removed IF required with a small application of WD-40 and a scraper tool. The once impenetrable bond will give way and after a quick shine with a basic window cleaner, it's as if the handle was never there. This gives the property owner peace of mind that they aren't taking a chance with an irreversible investment.

I claim:

1. A handle for a hinged door comprising:
A first portion having a flat affixing surface;
a second portion spaced apart from and parallel to the first portion;
a third portion connected to lateral edges of the first and second portion to form a U shape having an opening away from the third portion.
